(19) United States
(12) Patent Application Publication
(10) Pub. No.: US 2026/0081173 A1
(43) Pub. Date: Mar. 19, 2026

(54) STACK, BATTERY, AND BATTERY PACK

(71) Applicant: KABUSHIKI KAISHA TOSHIBA, Kawasaki-shi (JP)

(72) Inventors: Tomohiro MOCHIZUKI, Yokohama Kanagawa (JP); Ryunosuke SHISHIDO, Yokohama Kanagawa (JP); Yuma KIKUCHI, Kawasaki Kanagawa (JP); Masakuni IKAGAWA, Ebina Kanagawa (JP); Yuki WATANABE, Yokohama Kanagawa (JP)

(73) Assignee: KABUSHIKI KAISHA TOSHIBA, Kawasaki-shi (JP)

(21) Appl. No.: 19/396,427

(22) Filed: Nov. 21, 2025

Related U.S. Application Data
(63) Continuation of application No. PCT/JP2023/019140, filed on May 23, 2023.

(51) Int. Cl. H01M 4/62; H01M 4/02; H01M 4/13; H01M 4/36

(52) U.S. Cl. CPC H01M 4/628; H01M 4/13; H01M 4/366; H01M 4/622; H01M 2004/021

(57) ABSTRACT

According to one embodiment, a stack includes a first active material-containing layer provided in at least a surface of a first current collector and a first film covering at least a part of a surface of the first active material-containing layer including inorganic material particles having a median diameter D50 of 0.6 μm or less and a polymer. The first film has an average pore diameter of 0.5 μm or less, and satisfies formula (1) of 0<Ra₀₂/Ra₀₁≤1.5, where Ra₀₁ is a HSP distance between the inorganic material particles and n-methyl-2-pyrrolidone based on Hansen solubility parameter values, and Ra₀₂ is a HSP distance between the inorganic material particles and the polymer based on Hansen solubility parameter values.

### CROSS-REFERENCE TO RELATED APPLICATION

This application is a Continuation Application of PCT Application No. PCT/JP2023/019140, filed May 23, 2023, the entire contents of which are incorporated herein by reference.

### FIELD

Embodiments relate to a stack, a battery, and a battery pack.

### BACKGROUND

In a secondary battery such as a lithium secondary battery, a porous separator is disposed between a positive electrode and a negative electrode in order to avoid contact between the positive electrode and the negative electrode. As the separator, a self-supporting film distinct from the positive electrode and the negative electrode is used. For example, a microporous film made of a polyolefin resin is used. Such a separator is produced, for example, by extruding a melt containing a polyolefin resin composition in the form of a sheet, and removing substances except the polyolefin resin by extraction, followed by stretching the sheet.

Since the separator made of a resin film must have mechanical strength to avoid breakage during the production of a battery, it is difficult to reduce the thickness thereof beyond a certain value. Since the positive electrode and the negative electrode are stacked or wound with the separator interposed between them, if the separator is thick, the number of layers of the positive electrodes and the negative electrodes that can be housed per unit volume of a battery is limited. As a result, the battery capacity decreases. Also, when a separator made of a resin film poor in durability is used in a secondary battery, the separator deteriorates as charging and discharging are repeated, causing deterioration of the cycle performance of the battery.

In order to reduce the thickness of the separator, it has been studied to integrate a nanofiber film or an inorganic material film with either one of the positive electrode and the negative electrode.

### BRIEF DESCRIPTION OF THE DRAWINGS

FIG. 1 is a cross-sectional view of one example of a stack according to an embodiment.

FIG. 2 is a perspective view of a first electrode of the stack illustrated in FIG. 1.

FIG. 3 is a perspective view of a second electrode of the stack illustrated in FIG. 1.

FIG. 4 is a perspective view of another first electrode.

FIG. 5 is a cross-sectional view of another stack of the embodiment.

FIG. 6 is a perspective view of a first electrode of the stack illustrated in FIG. 5.

FIG. 7 is a perspective view of another first electrode.

FIG. 8 is a cross-sectional view of still another stack of the embodiment.

FIG. 9 is a schematic view of a step in the method for producing the stack of the embodiment.

FIG. 10 is a plan view 10 of the coating apparatus illustrated in FIG. 9.

FIG. 11 is a schematic view of a step in the method for producing a stack of the embodiment.

FIG. 12 is a partially cutaway perspective view of a battery according to an embodiment.

FIG. 13 is an exploded view of another battery of the embodiment.

FIG. 14 is an exploded perspective view of a battery pack according to an embodiment.

FIG. 15 is a block diagram of an electric circuit of the battery pack illustrated in FIG. 14.

FIG. 16 is a view schematically illustrating a relationship between the Hansen solubility spheres of inorganic material particles and a polymer.

FIG. 17 is a view schematically illustrating a scanning electron microscopic (SEM) image of a cross section of a first film of the stack of Comparative Example 2 taken along the thickness direction.

### DETAILED DESCRIPTION

According to one embodiment, a stack includes
a first current collector;
a first active material-containing layer provided in at least a surface of the first current collector; and
a first film covering at least a part of a surface of the first active material-containing layer in which the first current collector is not provided, the first film including inorganic material particles having a median diameter D₅₀ of 0.6 μm or less and a polymer, the first film having an average pore diameter of 0.5 μm or less, and the first film satisfying the following formula (1):

0<Ra₀₂/Ra₀₁≤1.5 (1)
where Ra₀₁ is a HSP distance between the inorganic material particles and n-methyl-2-pyrrolidone based on Hansen solubility parameter values (HSP values), and Ra₀₂ is a HSP distance between the inorganic material particles and the polymer based on Hansen solubility parameter values (HSP values).

According to another embodiment, a battery includes the stack according to the embodiment.

According to another embodiment, a battery pack includes a battery including the stack according to the embodiment.

Covering the surface of the active material-containing layer of an electrode with an insulating film containing inorganic material particles has been investigated. The insulating film containing inorganic material particles is formed, for example, by applying a slurry containing the inorganic material particles to a surface of the active material-containing layer and drying the slurry. In order to enhance the denseness of the film, it is desirable to reduce the diameter of the inorganic material particles.

However, it was found that when the median diameter of inorganic material particles is reduced to, for example, 0.6 μm or less, the inorganic material particles are easily aggregated; and that the insulation property of the film cannot be ensured due to the generation of a large number of coarse particles having a diameter of several tens of μm or more.

The present inventors conducted intensive studies. As a result, they made the following finding. Provided that among the HSP distances (Ra) based on individual Hansen solubility parameter values (HSP values) of inorganic material particles, a polymer, and a solvent (for example, n-methyl-2-pyrrolidone) contained in a slurry for forming a film, the HSP distance between the inorganic material particles and n-methyl-2-pyrrolidone is represented by Ra₀₁, and the HSP distance between the inorganic material particles and the polymer is represented by Ra₀₂, if the ratio (Ra₀₂/Ra₀₁) satisfies the following formula (1), aggregation of the inorganic material particles can be suppressed, so that the number of coarse particles can be sufficiently reduced, and a dense film can be obtained.

$$0 < {Ra}_{02} / {Ra}_{01} \leq 1.5 \qquad ( 1 )$$

The Hansen solubility parameter (HSP) is an index representing the affinity between two substances (alternatively, two components or two materials) and used for evaluating dispersibility between the two substances. The HSP distance (Ra) is the distance between the Hansen solubility parameter value (HSP value) of one of the substances and the Hansen solubility parameter value (HSP value) of the other substance. There is a tendency that the larger the HSP distance (Ra), the smaller the affinity between two substances; whereas, the smaller the HSP distance (Ra), the larger the affinity between two substances. The affinity between a polymer and inorganic material particles is determined by a complicated combination of elements such as the type of inorganic material particles, the surface state of the inorganic material particles, the type of polymer, the molecular weight of the polymer, the functional groups of the polymer, and the type of dispersion solvent.

If the above formula (1) is satisfied, the polymer is adsorbed to the surface of the inorganic material particles to generate a repulsive force between the inorganic material particles. With this, since the interaction between the inorganic material particles serves as the repulsive force, the aggregation of the inorganic material particles can be suppressed. As a result, the number of coarse particles can be sufficiently reduced. In addition, if the average pore diameter of the film containing inorganic material particles is controlled to 0.5 μm or less, it is possible to suppress a conductive additive contained in the active material-containing layer from mixing into the film to prevent deterioration of the insulation property of the film.

When the value of the ratio represented by (Ra₀₂/Ra₀₁) is larger than 1.5, the HSP distance Ra₀₂ between inorganic material particles and a polymer becomes larger than Ra₀₁, and the affinity between the polymer and the inorganic material particles becomes small. As a result, the adsorption of the polymer to the surface of the inorganic material particles becomes insufficient. Because of this, the inorganic material particles aggregate and the number of coarse particles increases.

Accordingly, when a film (hereinafter, referred to as a first film) containing inorganic material particles having a median diameter D₅₀ of 0.6 μm or less and a polymer, having an average pore diameter of 0.5 μm or less, and satisfying the formula (1) is used as the insulating film of the active material-containing layer (hereinafter, referred to as a first active material-containing layer), the self-discharge of the battery can be suppressed. Since the first film is highly dense, even if the film thickness is reduced, insulation property can be maintained. In addition, mixing of a component such as a conductive agent contained in the first active material-containing layer into the first film can be suppressed. Thus, the insulation property between the first electrode and the second electrode can be maintained by a film thinner than a self-supporting film such as a porous film made of a resin.

Now, a method for measuring the Hansen solubility parameter (HSP) will be described below. To each of 10 to types of dispersion mediums, inorganic material particles are added so as to have a concentration of 5 mass %. Also, to each of the same 10 to 20 types of dispersion mediums, a binder polymer powder is added so as to have a concentration of 5 mass %. Each of the samples thus obtained is subjected to measurement of pulse nuclear magnetic resonance (NMR) to obtain the relaxation time. Based on this, it is determined that each of 10 to 20 types of dispersion mediums is a good solvent or a poor solvent for each of the inorganic material particles and the binder polymer. From this result, Hansen solubility spheres for the inorganic material particles and the binder polymer are obtained by calculation. The distance between the central coordinates of these is calculated and regarded as the HSP distance (Ra) between them.

The stack further contains a second active material-containing layer and a second film, and the second active material-containing layer is integrated with the second film. With this, the self-discharge suppressing effect can be further enhanced.

The second film may be integrated with the first film. With this, the strength of adhesion between the first film and the second film can be improved.

The stack of the embodiment may further contain a first current collector and a first current collector tab. In this case, the first active material-containing layer is provided on a part of the first current collector. Further, in the first current collector, a first current collector tab is contained in the other part not holding the first active material-containing layer. Since the first film covers the portion of the first current collector tab including the boundary with the first active material-containing layer, it is possible to suppress contact of the first current collector tab with the counter electrode, and thereby suppress an internal short circuit.

### First Embodiment

Now, the stack of the first embodiment will be explained, below.

The stack of the first embodiment contains a first electrode, and may optionally contain a second electrode. The opposite pole of the first electrode is the second electrode. The first electrode may be a positive electrode and the second electrode may be a negative electrode. Alternatively, the first electrode may be a negative electrode and the second electrode may be a positive electrode. The first electrode contains a first film and a first active material-containing layer. The first electrode may further contain a first current collector and a first current collector tab. The second electrode contains a second film and a second active material-containing layer. The second electrode may further contain a second current collector and a second current collector tab. The first and second active material-containing layers may be formed on both of the main surfaces of the first and second current collectors, respectively, but can be formed only on one of the surfaces. The first electrode and the second electrode will be explained in detail.

### <First Electrode>

### <First Film>

The first film contains inorganic material particles having a median diameter D₅₀ of 0.6 μm or less and a polymer, has an average pore diameter of 0.5 μm or less, and satisfies the following formula (1).

$$0 < {Ra}_{02} / {Ra}_{01} \leq 1.5 \qquad ( 1 )$$

where Ra₀₁ is the HSP distance between inorganic material particles and n-methyl-2-pyrrolidone based on Hansen solubility parameter values (HSP values). Ra₀₂ is the HSP distance between the inorganic material particles and the polymer based on Hansen solubility parameter values (HSP values).

The first film covers a part or the whole of the surface of the first active material-containing layer on which the first current collector is not stacked. The first film may be fixed to the first active material-containing layer, for example, by adhesion or heat fusion.

Examples of the inorganic material may include oxides (for example, oxides of IIA to VA groups, transition metals, IIIB group, and IVB group such as Li₂O, BeO, B₂O₃, Na₂O, MgO, Al₂O₃, SiO₂, P₂O₅, CaO, Cr₂O₃, Fe₂O₃, ZnO, ZrO₂, TiO₂, magnesium oxides, silicon oxides, alumina, zirconia, and titanium oxides), zeolite (M_{2/n}O·Al₂O₃·xSiO₂·yH₂O (wherein M is a metal atom such as Na, K, Ca, and Ba, n is the number corresponding to the charge of the metal cation Mⁿ⁺, x and y are the mole number of SiO₂ and H₂O, and 2≤x≤10, 2≤y), nitrides (for example, BN, AlN, Si₃N₄, and Ba₃N₂), silicon carbide (SiC), zircon (ZrSiO₄), carbonate (for example, MgCO₃, and CaCO₃), sulfates (for example, CaSO₄, and BaSO₄) and composites of these (for example, steatite (MgO·SiO₂), forsterite (2MgO·SiO₂), and cordierite (2MgO·2Al₂O₃·5SiO₂)), which are a type of porcelain), tungsten oxides, and mixtures of these.

Other examples of inorganic materials include barium titanate, calcium titanate, lead titanate, γ-LiAlO₂, LiTiO₃, mullite (3Al₂O₃·2SiO₂), solid electrolyte, and mixtures of these.

Examples of the solid electrolyte include a solid electrolyte having no or low lithium ion conductivity and a solid electrolyte having lithium ion conductivity. Examples of the oxide particles having no or low lithium ion conductivity include lithium aluminum oxides (for example, LiAlO₂, LiₓAl₂O₃, where 0<x≤1), lithium silicon oxides, and lithium zirconium oxides.

Examples of the solid electrolyte having lithium ion conductivity include an oxide solid electrolyte having a garnet structure. The oxide solid electrolyte having a garnet structure has the advantages of being highly resistant to reduction and having a wide electrochemical window. Examples of the oxide solid electrolyte having a garnet structure include La₅₊ₓAₓLa₃₋ₓM₂O₁₂ (A is preferably at least one element selected from the group consisting of Ca, Sr, and Ba, M is preferably Nb and/or Ta, and x preferably falls within the range of 0.5 or less (including 0)), Li₃M₂₋₈L₂O₁₂ (M is preferably Nb and/or Ta, L preferably include Zr, and x preferably falls within the range of 0.5 or less (including 0)), Li₇₋₃ₓAlₓLa₃Zr₃O₁₂ (x preferably falls within the range of 0.5 or less (including 0)), and Li₇La₃Zr₂O₁₂. Of them, Li_{6.25}Al_{0.25}La₃Zr₃O₁₂, Li_{6.4}La₃Zr_{1.4}Ta_{0.6}O₁₂, Li_{6.4}La₃Zr_{1.6}Ta_{0.6}O₁₂, Li₇La₃Zr₂O₁₂ have high ionic conductivity and electrochemical stability, and are thus excellent in discharge performance and cycle life performance.

Examples of the solid electrolyte having lithium ion conductivity include a lithium phosphate solid electrolyte having a NASICON structure. Examples of the lithium phosphate solid electrolyte having a NASICON structure include LiM1₂(PO₄)₃, where M1 is one or more elements selected from the group consisting of Ti, Ge, Sr, Zr, Sn, and Al. Preferred examples include Li₁₊ₓAlₓGe_{2-X} (PO₄)₃, Li₁₊ₓAlₓZr₂₋ₓ (PO₄)₃, and Li₁₊ₓAlₓTi₂₋ₓ (PO₄)₃. Here, in each chemical formula, x preferably falls within the range of 0 or more and 0.5 or less. In addition, each of the solid electrolytes mentioned above has high ionic conductivity and high electrochemical stability. The lithium phosphate solid electrolyte having a NASICON structure and the oxide solid electrolyte having a garnet structure may be both used as a solid electrolyte having lithium ion conductivity.

Of the various types of inorganic material particles mentioned above, particles containing at least one compound selected from the group consisting of a titanium oxide, an aluminum oxide, and a barium sulfate are desirable. These inorganic material particles can be suppressed from being aggregated by specifying the HSP distances as shown in the formula (1). It is preferable that the surface of the titanium oxide particles is at least partly covered with an aluminum oxide. Particles of a titanium oxide such as titanium dioxide (TiO₂) can adsorb to a polymer by acid-base interaction. When the surface of the titanium dioxide particles is at least partly covered with aluminum oxide particles such as Al₂O₃, the acid-base property of the surface of the titanium dioxide particles can be changed. As a result, the affinity between the inorganic material particles and a polymer can be changed, that is, the HSP distance Ra₀₂ can be controlled. The affinity between the inorganic material particles and a polymer can also be changed by, e.g., the average molecular weight of the polymer, the unit constituting the polymer (homopolymer or copolymer). Examples of the titanium oxide include, but are not limited to, titanium dioxide. Examples of the titanium oxide include a lithium titanium oxide (for example, a lithium titanium oxide having a spinel structure or a ramsdellite structure).

The first film containing particles of at least one type of inorganic material selected from the above is a porous film made of an aggregate of inorganic material particles. For example, although there is an inorganic material having lithium ion conductivity like a solid electrolyte, most of the inorganic materials have low electron conductivity or insulation property. Because of this, the first film can function as a partition portion separating a positive electrode and a negative electrode. In order to suppress the self-discharge rate of a battery containing a stack produced by a method that will be described later, it is effective that the number of coarse particles having a particle size of several tens of μm or more, which are formed by aggregation of inorganic material particles in a slurry, is sufficiently reduced.

The first film, since it can keep a nonaqueous electrolyte in the porous portion, does not inhibit the permeation of Li ions.

The shape of the inorganic material particles is not particularly limited, and may be, for example, granular or fibrous shape. The inorganic material particles are desirably present in the form of primary particles, but primary particles may be aggregated to form secondary particles. Both of the primary particles and the secondary particles of the inorganic material particles may be present.

The specific surface area of the inorganic material particles can be 30 m²/g or less. The lower limit value of the specific surface area can be 2 m²/g.

If the median diameter D₅₀ of the inorganic material particles is 0.6 μm or less, the size of pores can be reduced. The median diameter D₅₀ of the inorganic material particles can be obtained as follows. The battery is disassembled and the electrode containing the first film is taken out. The electrode is processed by ion milling to obtain a cross section. The cut-out cross section of the electrode containing the first film is photographed by a scanning electron microscope (SEM) to obtain a cross-sectional SEM image. The obtained image is processed to obtain a median diameter D₅₀. Specifically, a straight line is drawn at an arbitrary point within the region of the cross-sectional SEM image corresponding to the first film, and the length along which the straight line and the inorganic material particles are overlapped, is measured. Length is measured at arbitrary 5 points and the median value of the lengths is defined as the median diameter D₅₀ of the inorganic material particles.

When the average pore diameter of the first film is specified as 0.5 μm or less, it is possible that a conductive additive contained in the first active material-containing layer is suppressed from entering into the first film to reduce the insulation property of the first film during the production process (described later). The average pore diameter more preferably falls within the range of 0.4 μm or less. The lower limit value of the average pore diameter can be 0.001 μm. The average pore diameter can be obtained as follows. A scanning electron microscopic (SEM) image of a cross section of the electrode containing the first film is obtained by the same manner as in measuring the median diameter D₅₀ of the inorganic material particles. In the region of the SEM image corresponding to the first film, a binarization treatment is performed to convert, for example, the color of inorganic material particles to white, and the color of pores to black. The image is analyzed to obtain the number of pores and the porosity. The porosity A1 (%) is calculated in accordance with the following formula (2).

$$A 1 ( \% ) = A 2 / A 3 \qquad ( 2 )$$

In the formula (2), A2 is the sum of the areas of pores (μm²), and A3 is the area of the image (μm²) analyzed.

The average pore area A4 (μm²) is calculated in accordance with the following formula (3).

$$A 4 = A 2 / A 5 \qquad ( 3 )$$

In the formula (3), A5 is the total number of pores.

The average pore diameter A6 (μm) is calculated in accordance with the following formula (4) on the assumption that the shape of pores is a circle.

$$[ Mathematical formula 1 ]$$

$$A 6 = 2 \times {( A 4 / π )}^{∧} ( 1 / 2 ) \qquad ( 4 )$$

The first film contains a polymer. The polymer may be a binder polymer that functions as a binder. Examples of the binder polymer include polytetrafluoroethylene (PTFE), polyvinylidene fluoride (PVdF), a fluorine rubber, a styrene-butadiene rubber, and mixtures of these.

When the total amount of the inorganic material particles and the polymer in the first film is 100 mass %, the amount of the polymer can be 20 mass % or less. Accordingly, the denseness of the first film can be enhanced. A more preferable range of the amount of the polymer can be set to fall within the range of 0.01 mass % or more and 20 mass % or less. The content of the inorganic material in the first film is set to fall desirably within the range of 80 mass % or more and 99.9 mass % or less. Accordingly, the insulation property of the first film can be enhanced.

The first film may contain a solvent such as n-methyl-2-pyrrolidone (NMP). Confirmation is made by the following method. The battery is disassembled, and the electrode containing the first film is taken out. The electrode containing the first film is dried to remove the adhered electrolytic solution. The first film is peeled off from the dried first electrode containing the first film by, e.g., tweezers. When the first film is peeled off, inorganic material particles are obtained. The mass of the inorganic material particles is measured and regarded as W1 (mg). Acetone is added to the inorganic material particles, and the mixture is stirred for 24 hours or more with shaking. The total mass of acetone and inorganic material particles is measured and regarded as W2 (mg). The mixture is sufficiently mixed by shaking, and then allowed to stand and precipitate a solid content. Thereafter, the supernatant is analyzed by gas chromatography, and the concentration X (μg/mL) of NMP in acetone is determined. The amount N (μg/g) of NMP per unit mass is calculated in accordance with the following formula.

$$N = X * ( W 2 - W 1 ) / ( 0.7908 * W 1 )$$

wherein 0.7908 is the density of acetone at 25° C. (mg/mL)

The thickness of the first film can be set to 1 μm or more and 30 μm or less. The thickness of the first film is measured by a method according to the JIS standard (JIS B 7503-1997). Specifically, the thickness is measured by a contact-type digital gauge. A sample is placed on a stone surface plate, and a digital gauge fixed to the stone surface plate is used. As the measuring terminal, a flat terminal having a tip of φ5.0 mm is used. The measuring terminal, which is placed at a distance of 1.5 mm or more and less than 5.0 mm above a sample, is brought closer to the sample. The distance thereof in contact with the sample is determined as the thickness of the sample.

### <First Active Material-Containing Layer>

The first active material-containing layer is stacked on at least one of the surfaces of a first current collector. The first active material-containing layer contains a first active material, and may optionally contain a binder and a conductive agent.

As the first active material, a positive electrode active material or a negative electrode active material is used. As the first active material, the positive electrode active material is desirably used. The number of types of the active materials can be one or two or more.

As the positive electrode active material, for example, a lithium-containing oxide (for example, a lithium transition metal composite oxide) can be used. Examples thereof include Li₃CoO₂ (0<a≤1), LiₐNi₁₋ₓCoₓO₂ (0<a≤1, 0<x≤0.3), LiₐMnₓNi_{y}CoO₂ (0<a≤1, 0<x<0.5, 0<y<0.5, 0≤z<0.5), LiₐMn₂₋ₓMₓO₄ (0<a≤1, M is at least one element selected from the group consisting of Mg, Co, Al, and Ni, 0<x<0.2), and LiₐMPO₄ (0<a≤1, and M is at least one element selected from the group consisting of Fe, Co, and Ni). The number of types of the lithium-containing oxides can be one or two or more.

As the negative electrode active material, e.g., a carbon material including graphite, and a tin-silicon alloy material, can be used, but a titanium-containing oxide is preferably used. Examples of the titanium-containing oxide include a lithium titanium oxide having a spinel structure (for example, Li₄₊ₓTi₅O₁₂ (0≤x≤3)), a lithium titanium oxide having a ramsdellite structure (for example, Li_{2+y}Ti₃O₇ (0≤y≤3)), a metal composite oxide containing Ti and at least one type of element selected from the group consisting of P, V, Sn, Cu, Ni, and Fe, and a niobium titanium-containing oxide such as TiNb₂O₇ and Ti₂Nb₁₀O₁₉. Examples of the metal composite oxide containing Ti and at least one type of element selected from the group consisting of P, V, Sn, Cu, Ni, and Fe include TiO₂-P₂O₅, TiO₂—V₂O₅, TiO₂—P₂O₈—SnO₂, and TiO₂—P₂O₅-MO (M is at least one element selected from the group consisting of Cu, Ni, and Fe). The metal composite oxide and niobium titanium-containing oxide can be changed into an oxide containing lithium by inserting lithium by charging.

The active material may be a single primary particle, a secondary particle formed of aggregated primary particles, or a mixture of primary particles and secondary particles.

The average particle size of the primary particles of the negative electrode active material preferably falls within the range of 0.001 to 1 μm. The average particle size can be determined by examining the negative electrode active material using SEM. The particle shape may have either granular or fibrous shape. In the case of the fibrous shape, the diameter of a fiber is preferably 0.1 μm or less. Specifically, the average particle size of the primary particles in the negative electrode active material can be measured from images obtained using an electron microscope (e.g., SEM). When a lithium titanium oxide (also referred to as lithium titanate) having an average particle size of 1 μm or less is used as a negative electrode active material, a negative electrode active material-containing layer having highly flat surface is obtained. When a lithium titanium oxide (lithium titanate) is used, the negative electrode potential is higher than the negative electrode potential of a lithium ion secondary battery using a general carbon negative electrode. Because of this, precipitation of lithium metal does not occur, in principle. In the negative electrode active material containing a lithium titanium oxide (lithium titanate), since the expansion and contraction caused by charge and discharge reactions are small, the collapse of the crystal structure of the active material can be prevented.

Examples of the conductive agent include acetylene black, carbon black, graphite, and mixtures of these.

Examples of the binder include polytetrafluoroethylene (PTFE), polyvinylidene fluoride (PVdF), a fluorine rubber, a styrene-butadiene rubber, and mixtures of these. The binder has a function to bind an active material and a conductive agent.

In the positive electrode active material-containing layer, the contents of the active material, the conductive agent, and the binder are preferably 80 mass % or more and 97 mass % or less, 2 mass % or more and 18 mass % or less, and 1 mass % or more and 17 mass % or less, respectively. In the negative electrode active material-containing layer, the contents of the negative electrode active material, the conductive agent, and the binder are preferably 70 mass % or more and 98 mass % or less, 1 mass % or more and 28 mass % or less, and 1 mass % or more and 28 mass % or less, respectively.

The thickness of the first active material-containing layer can be 5 μm or more and 100 μm or less.

### <First Current Collector>

The first current collector may be a conductive sheet. Examples of the conductive sheet include a foil made of a conductive material. Examples of the conductive material include aluminum, an aluminum alloy, copper, and nickel.

The thickness of the first current collector can be, for example, 5 μm or more and 40 μm or less.

In the first current collector, a first current collector tab is contained in the part that does not hold the first active material-containing layer. Since the first film covers the portion of the first current collector tab including the boundary with the first active material-containing layer, it is possible to suppress contact of the first current collector tab with the counter electrode, and thereby suppress an internal short circuit. The first current collector tab may be formed of the same material as that of the current collector, but a collector tab may be prepared separately from the current collector, connected to the current collector by, e.g., welding, and put into use.

### <Second Electrode>

### <Second Active Material-Containing Layer>

The second active material-containing layer is stacked on at least one of the surfaces of the second current collector. The second active material-containing layer contains the second active material, and may optionally contain a binder and a conductive agent.

As the second active material, a positive electrode active material or a negative electrode active material is used. A negative electrode active material is desirably used as the second active material. The number of types of the active materials can be one or two or more. Examples of the positive electrode active material and the negative electrode active material may include the same materials as those explained for the first active material.

Since the second active material-containing layer contains a titanium-containing oxide as an active material, precipitation of lithium dendrite on the first film and the second film can be avoided. As a result, the charge-and-discharge cycle life of the secondary battery can be improved.

Examples of the binder and the conductive agent may include the same materials as those explained for the first active material.

### <Second Current Collector>

The second current collector may be a conductive sheet. Examples of the conductive sheet include the same as those explained for the first current collector.

The thickness of the second current collector can be, for example, 5 μm or more and 40 μm or less.

In the second current collector, a second current collector tab is contained in the part which does not hold the second active material-containing layer. Since the second film covers the portion including the boundary between the second current collector tab and the second active material-containing layer, it is possible to suppress contact of the second current collector tab with the counter electrode, and thereby suppress an internal short circuit. The second current collector tab may be formed of the same material as that of the current collector, but a collector tab may be prepared separately from the current collector, connected to the current collector by, e.g., welding, and put into use.

### <Second Film>

The second film contains organic fibers. The second film may be a porous film prepared by depositing organic fibers in the plane direction. The second film has a front surface and a back surface. One of the main surfaces of the second film corresponds to the front surface, and the other main surface corresponds to the back surface. One of the front surface and the back surface of the second film is in contact with the front surface of the first film. For example, the second film may be integrated with the front surface of the first film or the front surface of the second active material-containing layer facing the first active material-containing layer. How the second film is integrated with the first film or the second active material-containing layer is not particularly limited.

The organic fiber contains, for example, at least one organic material selected from the group consisting of polyamideimide, polyamide, polyolefin, polyether, polyimide, polyketone, polysulfone, cellulose, polyvinyl alcohol (PVA), and polyvinylidene fluoride (PVdF). Examples of the polyolefin include polypropylene (PP) and polyethylene (PE). The number of types of the organic fiber can be one or two or more. The organic fiber is preferably at least one selected from the group consisting of polyimide, polyamide, polyamideimide, cellulose, PVdF, and PVA, and more preferably at least one selected from the group consisting of polyimide, polyamide, polyamideimide, cellulose, and PVdF.

Since polyimide is insoluble, infusible and not decomposed even at 250 to 400° C., a second film excellent in heat resistance can be obtained.

The organic fiber preferably has a length of 1 mm or more and an average diameter of 2 μm or less, and more preferably has an average diameter of 1 μm or less. Such a second film has, e.g., sufficient strength, porosity, air permeability, pore size, electrolyte resistance, and redox resistance, and thus favorably functions as a separator.

The average diameter of the organic fiber can be measured under observation by a focused ion beam (FIB) apparatus. The length of the organic fiber is obtained based on the length measured under observation by the FIB apparatus.

Since it is necessary to ensure ion permeability and electrolyte retention, 30% or more of the total volume of the fibers forming the second film is preferably an organic fiber having an average diameter of 1 μm or less, more preferably an organic fiber having an average diameter of 350 nm or less, and still more preferably an organic fiber having an average diameter of 50 nm or less.

It is more preferable that the volume of the organic fibers having an average diameter of 1 μm or less (more preferably 350 nm or less, still more preferably 50 nm or less) occupies 80% or more of the total volume of the fibers forming the second film. Such a state can be confirmed under observation of the second film by a scanning ion microscope (SIM). It is more preferable that the organic fibers having a thickness of 40 nm or less occupy 40% or more of the total volume of the fibers forming the second film. The small diameter of the organic fiber means that the effect of hindering ion movement is small.

In at least a part of the entire surface including the front surface and the back surface of the organic fiber layer, a cation exchange group is preferably present. Since the movement of ions such as lithium ions passing through a separator is promoted by the cation exchange group, the performance of the battery is enhanced. Specifically, quick charge and discharge can be performed over a long period of time. Examples of the cation exchange group include, but are not limited to, a sulfonic acid group and a carboxylic acid group. The fiber having a cation exchange group on the surface can be formed, for example, by an electrospinning method using a sulfonated organic material.

The second film preferably has pores. The average pore diameter is preferably 5 nm or more and 10 μm or less. The porosity is preferably 70% or more and 90% or less. If such pores are provided, a separator having not only an excellent ion permeability but also an excellent electrolyte impregnation property can be obtained. The porosity is more preferably 80% or more. The average pore diameter and porosity of pores can be determined by a mercury intrusion method, calculation from volume and density, SEM observation, SIM observation, and a gas adsorption-desorption method. The porosity is desirably calculated from the volume and density of the second film. The average pore size is desirably measured by a mercury intrusion method or a gas adsorption method. The large porosity of the second film means that the effect of hindering the movement of ions is small.

It is desirable that the thickness of the second film falls within the range of 12 μm or less. The lower limit of the thickness is not particularly limited, but may be 1 μm.

In the second film, since the porosity can be increased if the organic fibers are contained with a low density, it is not difficult to obtain a layer having a porosity of, for example, about 90%. It is extremely difficult to form a layer having such a large porosity with particles.

The second film is more favorable than a deposit of inorganic fibers in terms of unevenness, ease of cracking, electrolyte retention property, adhesion, bending property, porosity, and ion permeability.

The second film may contain particles of an organic compound. The particles are made of, for example, the same material as that of the organic fibers. The particles may be integrally formed with the organic fibers.

The second film may be formed on the second active material-containing layer, but may be formed on the first film. Alternatively, the second film may be formed on the surfaces of both the second active material-containing layer and the first film. In either case, it is preferable that one of the front surface and the back surface of the second film is in contact with the front surface of the first film.

The second film is formed by, for example, an electrospinning method. In the electrospinning method, the first electrode or the second electrode on which the second film is to be formed is grounded as a ground electrode. When the second film is to be formed on the first electrode, the first electrode having the first film already formed is prepared.

The liquid raw material (for example, a raw material solution) is charged by the voltage applied to the spinning nozzle, and the charge amount per unit volume of the raw material solution is increased by volatilization of the solvent from the raw material solution. When the volatilization of the solvent and a subsequent increase in the charge amount per unit volume continuously occur, the raw material solution discharged from the spinning nozzle extends in the longitudinal direction and is deposited as a nano-sized organic fiber on the first electrode or the second electrode serving as a ground electrode. A Coulomb force is generated between the organic fiber and the ground electrode due to a potential difference between the nozzle and the ground electrode. Accordingly, the nano-sized organic fiber can increase the contact area between the second film and the first film. Since the organic fiber can be deposited on the first electrode or the second electrode by the Coulomb force, the peel strength of the second film from the electrode can be enhanced. The peel strength can be controlled by adjusting, for example, the solution concentration and the sample-nozzle distance. Note that, when the second film is not formed on the first and second current collector tabs, it is preferable that the first and second current collector tabs are masked and then the second film is formed. This case is illustrated in FIG. 11. FIG. 11 is a perspective view of a step of forming a second film on the second electrode. As illustrated in FIG. 11, the second film 5 is directly formed on the second active material-containing layer 2b and the second current collector tab 2c by depositing the raw material solution discharged from nozzle N as an organic fiber. One of the sides of the second current collector tab 2c and the vicinity thereof are covered with mask M. Accordingly, the second film 5 becomes a porous film containing organic fibers deposited across the surface of the second active material-containing layer 2b and a portion of the surface of the second current collector tab 2c adjacent to the second active material-containing layer 2b.

The second film can be easily formed on the electrode surface by the electrospinning method. Since a single continuous fiber is formed by the electrospinning method in principle, a thin film having resistance to breakage due to bending and cracking of a film can be ensured. The feature of the organic fiber constituting the second film being a seamless and continuous fiber means that the probability of fraying or partial loss of the second film is low. This is favorable in view of suppressing self-discharge.

As the liquid-state raw material to be used in electrospinning, for example, a raw material solution prepared by dissolving an organic material in a solvent is used. Examples of the organic material may include the same materials as those mentioned for the organic material constituting the organic fiber. The organic material is dissolved in a solvent in a concentration of, for example, about 5 to 60 mass % and put into use. The solvent for dissolving the organic material is not particularly limited and any solvent can be used. Examples of the solvent include dimethylacetamide (DMAc), dimethylsulfoxide (DMSO), N,N′-dimethylformamide (DMF), n-methyl-2-pyrrolidone (NMP), water, and alcohols. For an organic material low in solubility, electrospinning is performed while melting a sheet-form organic material with, e.g., a laser. In addition, it is also acceptable to mix a high boiling-point organic solvent and a low-melting point solvent.

While applying a voltage to a spinning nozzle by a high pressure generator, a raw material is discharged from the spinning nozzle over the surface of a predetermined electrode to form the second film. The voltage to be applied is appropriately determined according to, e.g., the type of solvent/solute, the boiling point/vapor pressure curve of the solvent, the solution concentration, the temperature, the nozzle shape, and the sample-nozzle distance. For example, the potential difference between a nozzle and a workpiece can be set to 0.1 to 100 kV. The feed rate of a raw material is also appropriately determined according to, e.g., the solution concentration, solution viscosity, temperature, pressure, applied voltage, and nozzle shape. In the case of a syringe type, for example, the feed rate can be set to about 0.1 to 500 μl/min per nozzle. In the case of multiple nozzles or slits, the feed rate may be determined depending on the opening area of them.

Since the organic fiber in a dry state is directly formed on the surface of the electrode, impregnation of the electrode with the solvent contained in the raw material can be substantially avoided. The amount of a solvent remaining in the electrode is extremely low at a ppm level or less. The solvent remaining within the electrode produces an oxidation-reduction reaction to cause loss of the battery, leading to the deterioration of battery performance. According to this embodiment, since the probability of causing such disadvantage is greatly reduced, the performance of the battery can be enhanced.

The thickness of the second film is measured by a method according to the JIS standard (JIS B 7503-1997). Specifically, the thickness is measured by a contact-type digital gauge. A sample is placed on a stone surface plate, and a digital gauge fixed to the stone surface plate is used. As the measuring terminal, a flat terminal having a tip of φ5.0 mm is used. The measuring terminal, which is placed at a distance of 1.5 mm or more and less than 5.0 mm above a sample, is brought closer to the sample. The distance thereof in contact with the sample is determined as the thickness of the sample.

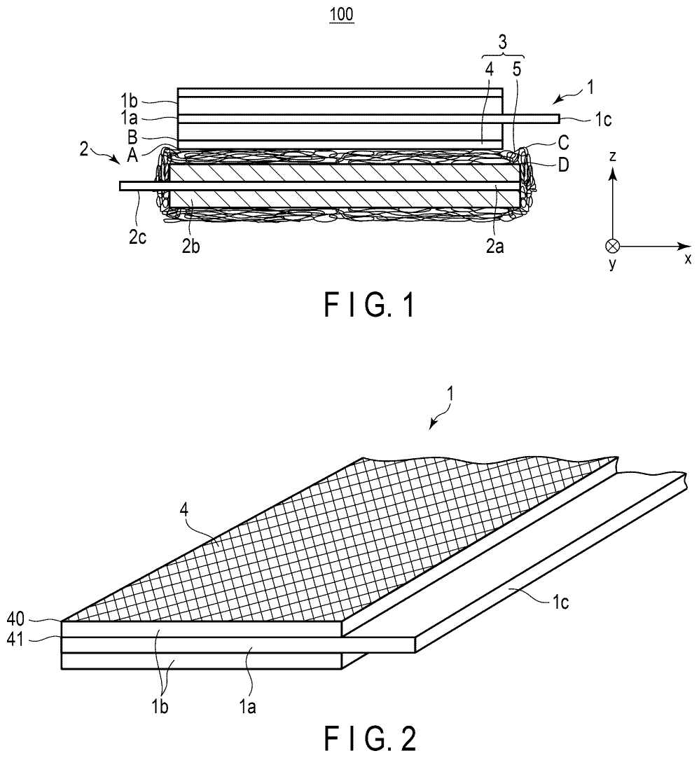

An example of the stack of the first embodiment will be explained with reference to FIGS. 1 to 8. The same reference numerals are used to designate common members in the figures and the explanation thereof will be omitted. FIG. 1 is a cross-sectional view of a stack according to an embodiment. In FIG. 1, the thickness direction of the stack is indicated by the z-axis direction, the extending direction of the collector tab is indicated by the x-axis direction, and the direction orthogonal to the extending direction of the collector tab is indicated by the y-axis direction. The cross-sectional view of FIG. 1 is a cross-sectional view of the stack taken along the extending direction (x-axis direction) of the collector tab. A stack 100 illustrated in FIG. 1 contains a first electrode 1, a second electrode 2, and a separator 3. The first electrode 1, as illustrated in FIGS. 1 and 2, contains a first current collector 1a, a first active material-containing layer 1b having a first front surface 40 and a first back surface 41, and a first current collector tab 1c. The first current collector 1a is a conductive sheet. The first active material-containing layer 1b is held on a part of each of both main surfaces of the first current collector 1a. In each of the main surfaces of the first current collector 1a, the active material-containing layer is not held on a side (for example, a long side and a short side) or in the vicinity thereof. The portion not holding the active material-containing layer and formed in parallel to a side (for example, a side parallel to the y-axis direction) of the first current collector 1a functions as the first current collector tab 1c. Of the surfaces of the first active material-containing layer 1b, the surface in contact with the first current collector 1a is the first back surface 41.

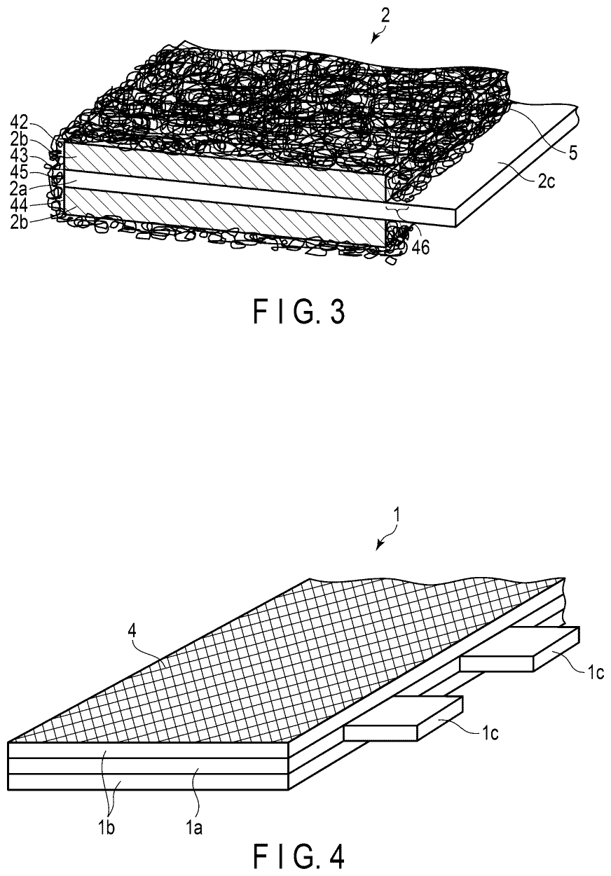

The second electrode 2, as illustrated in FIG. 3, contains a second current collector 2a, a second active material-containing layer 2b having a second front surface 42 and a second back surface 43, and a second current collector tab 2c. The second current collector 2a is a conductive sheet. The second active material-containing layer 2b is held on a part of each of both main surfaces of the second current collector 2a. In each of the main surfaces of the second current collector 2a, the active material-containing layer is not held on a side and in the vicinity thereof. The portion not holding the active material-containing layer and formed in parallel to a side (for example, a side parallel to the y-axis direction) of the second current collector 2a functions as the second current collector tab 2c. Of the surfaces of the second active material-containing layer 2b, the surface in contact with the second current collector 2a is the second back surface 43.

The separator 3 contains a first film 4 containing inorganic material particles and a second film 5 containing organic fibers. The first film 4 has a front surface A and a back surface B, and the second film 5 has a front surface C and a back surface D. As illustrated in FIGS. 1 and 2, the back surface B of the first film 4 covers the first surface 40 of each of the first active material-containing layers 1b. How the first film 4 is fixed to the first active material-containing layer 1b is not particularly limited, for example, by, adhesion or thermal fusion. The second film 5, as illustrated in FIG. 3, covers the second surface 42 of each of the second active material-containing layers 2b, four side surfaces 44 orthogonal to the second surface 42, three end faces 45 exposed on the surface of the second electrode 2 of the second current collector 2a, and a portion 46 including boundaries with the second active material-containing layers 2b on both main surfaces of the second current collector tab 2c. Thus, the first active material-containing layer 1b and the second active material-containing layer 2b face each other with the first film 4 and the second film 5 interposed between them.

According to the stack having the structure illustrated in FIG. 1, a battery high in energy density and low in self-discharge can be realized. In addition, since the second film 5 covers the single end face 45 along the y-axis direction of the second current collector 2a and the portion 46 of the surface of the second current collector tab 2c including boundaries with the second active material-containing layers 2b, an internal short circuit due to contact between the first electrode and the second electrode 2 is reduced.

Note that, the first and second current collector tabs are not limited to single sides of the first and second current collectors not supporting the active material-containing layer. For example, a plurality of belt-like portions protruding from single sides of the first and second current collectors can be used as the first and second current collector tabs. An example of this is illustrated in FIG. 4. FIG. 4 shows another first electrode 1. As illustrated in FIG. 4, a plurality of belt-like portions protruding in the x-axis direction from a side along the y-axis direction of the first current collector 1a may be used as the first current collector tabs 1c.

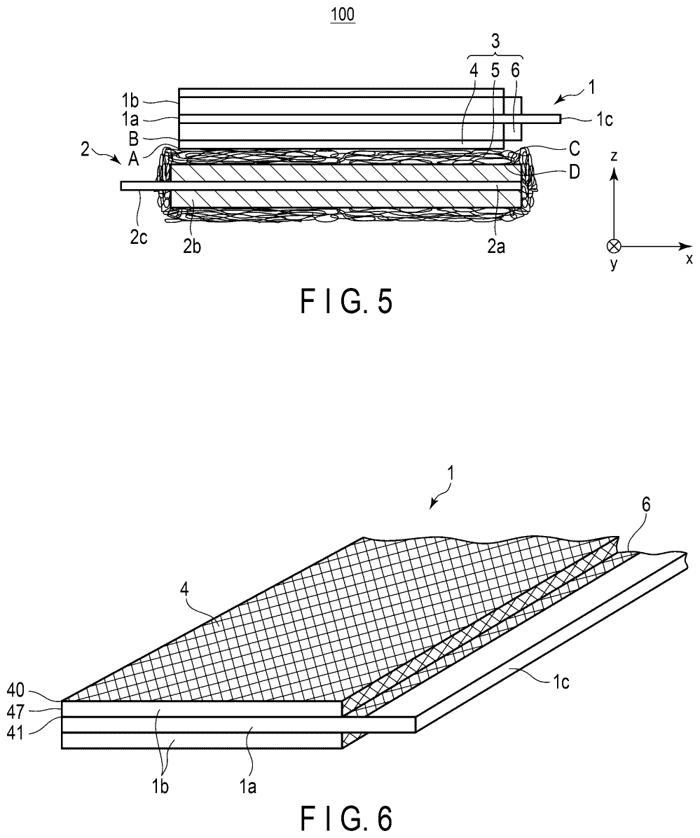

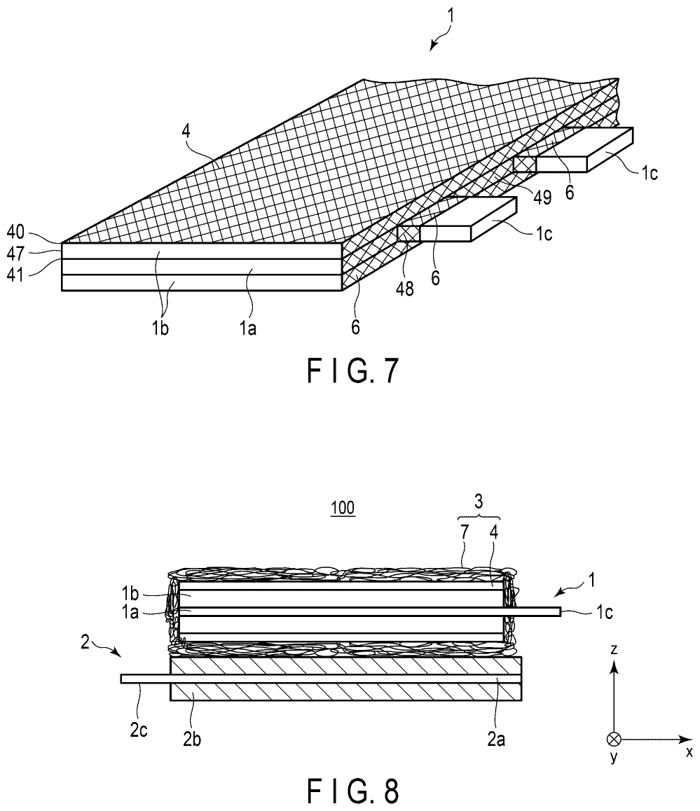

The first film can be formed only on at least one of the main surfaces of the first active material-containing layer, but at least a part of the surface of the first current collector tab may be covered with the first film. An example of this is illustrated in FIGS. 5 and 6. In FIG. 5, the thickness direction of the stack is indicated by the z-axis direction, the extending direction of the collector tab is indicated by the x-axis direction, and the direction orthogonal to the extending direction of the collector tab is indicated by the y-axis direction. The cross-sectional view of FIG. 5 is a cross-sectional view of the stack 100 taken along the extending direction (x-axis direction) of the collector tab. For each of the two first active material-containing layers 1b, the four side surfaces 47 orthogonal to the main surface are covered with the first film 6. The first film 6 also covers respective portions of both main surfaces of the first current collector tab 1c. Each of the portions is adjacent to the first active material-containing layer 1b, and includes a boundary between the first active material-containing layer 1b and the first current collector tab 1c. The portion where the first film 6 is provided is present close to an end face positioned on the side opposite to the side at which the second current collector tab 2c of the second electrode extends. Since the first film 6 is provided, it is possible to reduce an internal short circuit due to contact between the first current collector tab 1c of the first electrode and the end face of the second electrode. Note that, when a plurality of belt-like portions protruding from a side along the y-axis direction of the first current collector 1a as illustrated in FIG. 7 are used as the first current collector tab 1c, it is desirable that the portion 48 of each of the four surfaces of the first current collector tab 1c adjacent to the first current collector 1a and the end face 49 of the first current collector 1a positioned between the first current collector tabs 1c are covered with the first film 6. This configuration is effective for reducing an internal short circuit.

The second film may be formed on the second electrode, but may be formed on the first electrode instead of the second electrode. An example of this is illustrated in FIG. 8. In FIG. 8, the thickness direction of the stack is indicated by a z-axis direction, the extending direction of the collector tab is indicated by the x-axis direction, and the direction orthogonal to the extending direction of the collector tab is indicated by the y-axis direction. The cross-sectional view of FIG. 8 is a cross-sectional view of the stack 100 taken along the extending direction (x-axis direction) of the collector tab. The second film 7 covers the surface of the first film 4 and all of the end faces of the first electrode. The second film 7 also covers a portion including a boundary with the first active material-containing layer 1b on each of both main surfaces of the first current collector tab 1c.

The second electrode is disposed such that the second active material-containing layer 2b faces the first active material-containing layer 1b with the separator 3 formed of the first film 4 and the second film 7 interposed between them. A portion of the main surface of the first current collector tab 1c adjacent to the first active material-containing layer 1b is covered with the second film 7, and an end face of the first electrode positioned on a side opposite to a side where the first current collector tab 1c protrudes is covered with the second film 7. Owing to this configuration, self-discharge and internal short circuit are suppressed.

A method for producing the stack of the embodiment will be explained below.

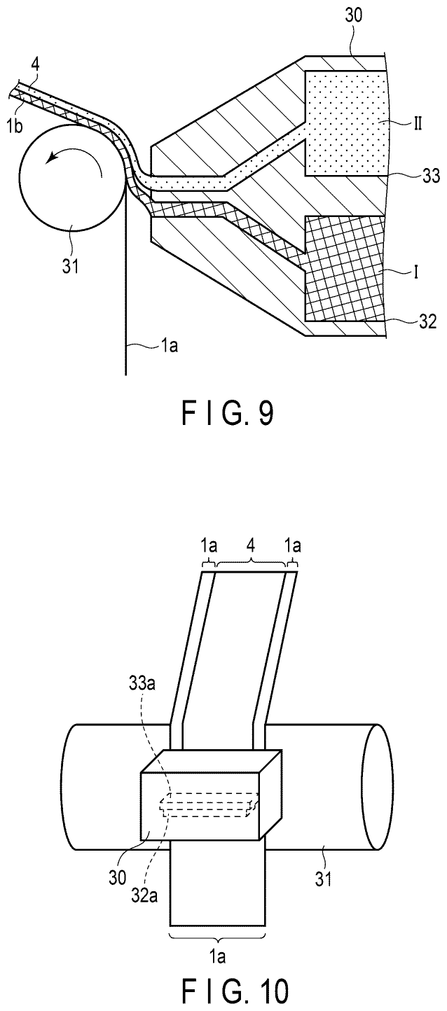

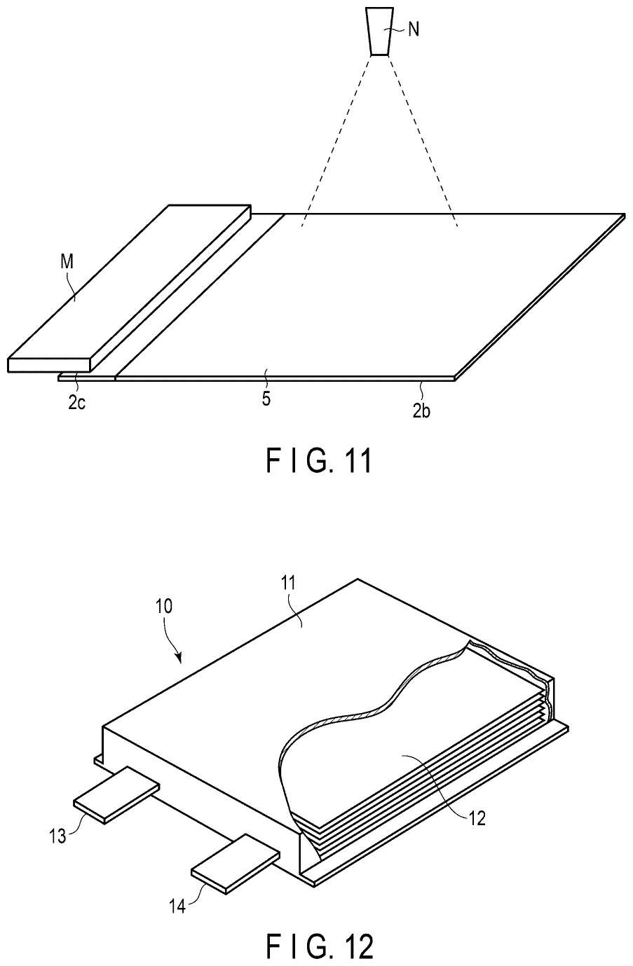

A slurry (hereinafter, referred to as slurry I) containing the first active material and a slurry (hereinafter, referred to as slurry II) containing an inorganic material are simultaneously applied to at least one of the main surfaces of the first current collector. An example of the coating step is illustrated in FIGS. 9 and 10. A coating apparatus 30 has a tank 32 storing slurry I and a tank 33 storing slurry II, and is configured to simultaneously apply slurry I and slurry II to the substrate. A long first current collector 1a is conveyed to the slurry discharge port of the coating apparatus 30 by a conveying roller 31, before being cut into pieces of a predetermined size. In FIG. 10, a slurry I discharge port 32a is positioned on the upstream side of the current collector from a slurry II discharge port 33a. Since discharge ports are arranged as mentioned above, slurry I is applied from the coating apparatus 30 onto the first current collector 1a except both edge portions in the short side direction. Subsequently, before slurry I is dried, slurry II is overcoated so as to spread out of the application region of slurry I. Since slurry II is overcoated on slurry I, slurry II easily conforms to the surface shape of slurry I. Thereafter, slurry is dried. The dried slurry is subjected to roll pressing and cut into pieces of a predetermined size to obtain first electrodes.

On the other hand, the slurry containing the second active material is applied to the second current collector, and then dried. The dried slurry is subjected to roll pressing, and cut into pieces of a predetermined size to obtain second electrodes. A second film is formed on the second electrode by an electrospinning method. Subsequently, pressing may be performed. The pressing method may be roll press or flat press.

The first electrode and the second electrode are stacked so as to face each other with the first film and the second film interposed between them to obtain the stack of the embodiment.

In the production method mentioned above, since slurry II contains inorganic material particles having a median diameter D₅₀ of 0.6 μm or less and a polymer, and has a composition satisfying the formula (1), aggregation of the inorganic material particles in slurry II can be suppressed. Thus, when slurry I is overcoated with slurry II, or in the following drying, pressing, or cutting step, mixing of the conductive agent of slurry I into slurry II can be prevented.

The stack of the first embodiment explained above contains a first active material-containing layer and a first film containing inorganic material particles having a median diameter D₅₀ of 0.6 μm or less and a polymer, having an average pore diameter of 0.5 μm or less, and satisfying the following formula (1).

$$0 < {Ra}_{02} / {Ra}_{01} \leq 1.5 \qquad ( 1 )$$

where Ra₀₁ is the HSP distance between inorganic material particles and n-methyl-2-pyrrolidone based on Hansen solubility parameter values (HSP values). Ra₀₂ is the HSP distance between the inorganic material particles and the polymer based on Hansen solubility parameter values (HSP values).

According to the first film, aggregation of the inorganic material particles can be suppressed to reduce generation of coarse particles. As a result, mixing of the conductive agent contained in the first active material-containing layer into the first film is suppressed, and thus, the deterioration of the insulation property of the first film can be prevented. Therefore, the battery having the stack can be suppressed in self-discharge. Further, this battery can be improved in durability performance such as cycle life performance.

### Second Embodiment

The battery of the second embodiment contains the stack of the first embodiment. The battery may further contain an electrolyte and a container member that can house the electrolyte and the stack.

A plurality of stacks may be used in a battery as an electrode group. A plurality of stacks can be stacked such that the first film and the second film are positioned between the first active material-containing layer of a certain stack and the second active material-containing layer of a stack positioned adjacent to the stack. The shape of the electrode group is not limited to this shape, and one or more stacks wound in a spiral or flat spiral shape may be used as the electrode group.

The battery may further have a first electrode terminal electrically connected with the first current collector tab and a second electrode terminal electrically connected with the second current collector tab.

As the electrolyte, for example, a nonaqueous electrolyte is used. Examples of the nonaqueous electrolyte include a liquid nonaqueous electrolyte prepared by dissolving an electrolyte in an organic solvent, and a gel-type nonaqueous electrolyte, which is a composite of a liquid electrolyte and a polymer material. The liquid nonaqueous electrolyte can be prepared, for example, by dissolving an electrolyte in an organic solvent in a concentration of 0.5 mol/L or more and 2.5 mol/L or less.

Examples of the electrolyte include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide [LiN(CF₃SO₂)₂], and mixtures of these. It is preferable that the electrolyte is hardly oxidized even at a high potential, and LiPF₆ is most preferred.

Examples of the organic solvent include cyclic carbonates such as propylene carbonate (PC), ethylene carbonate (EC), and vinylene carbonate; linear carbonates such as diethyl carbonate (DEC), dimethyl carbonate (DMC), and methylethyl carbonate (MEC); cyclic ethers such as tetrahydrofuran (THF), 2-methyltetrahydrofuran (2MeTHF), and dioxolane (DOX); linear ethers such as dimethoxyethane (DME) and diethoxyethane (DEE); γ-butyrolactone (GBL), acetonitrile (AN), and sulfolane (SL). Such an organic solvent may be used alone or as a mixture of two or more types.

Examples of the polymer material include polyvinylidene fluoride (PVdF), polyacrylonitrile (PAN), and polyethylene oxide (PEO).

As the nonaqueous electrolyte, e.g., a room temperature molten salt (ionic melt) containing lithium ions, a polymer solid electrolyte, or an inorganic solid electrolyte may be used.

As the container member, for example, a metal container, or a container made of a laminate film can be used.

The shape of the battery is not particularly limited. Various shapes such as a cylindrical shape, a flat shape, a thin shape, a square shape, and a coin shape can be employed.

FIG. 12 is a partially cutaway perspective view of a secondary battery according to an embodiment. FIG. 12 is a view of a secondary battery using a laminate film as a container member. A secondary battery 10 illustrated in FIG. 12 contains a container member 11 made of a laminate film, an electrode group 12, a first electrode terminal 13, a second electrode terminal 14, and a nonaqueous electrolyte (not shown). The electrode group 12 contains a plurality of stacks of the embodiment, and has a structure formed by stacking a first electrode and a second electrode with a separator formed of a first film and a second film interposed between them. The nonaqueous electrolyte (not shown) is held or impregnated in the electrode group 12. A first current collector tab of the first electrode is electrically connected to the first electrode terminal 13. A second current collector tab of the second electrode is electrically connected to the second electrode terminal 14. As illustrated in FIG. 12, the first electrode terminal 13 and the second electrode terminal 14 are disposed with a distance between them and tips of them each protrude outward from a side of the container member 11.

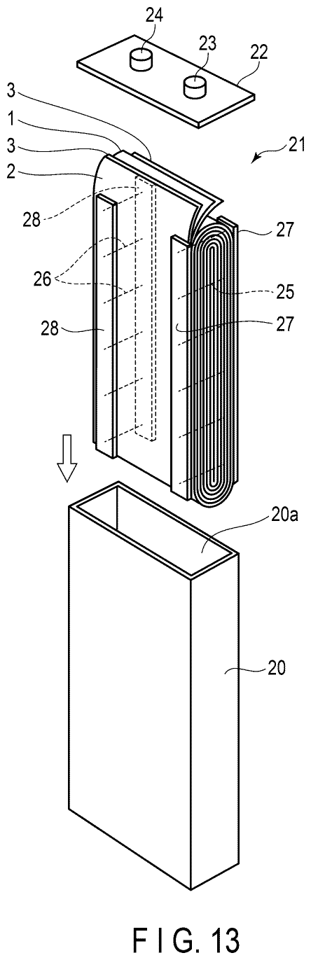

FIG. 13 is an exploded perspective view of another secondary battery according to the embodiment. FIG. 13 is a view showing a secondary battery using a square metal container as a container member. The secondary battery illustrated in FIG. 13 contains a container member 20, a wound electrode group 21, a lid 22, a first electrode terminal 23, a second electrode terminal 24, and a nonaqueous electrolyte (not shown). The wound electrode group 21 has a structure in which the stack of the embodiment is wound in a flat spiral shape. In the wound electrode group 21, a first current collector tab 25 wound in a flat spiral shape is positioned on one circumferential end face, and a second current collector tab 26 wound in a flat spiral shape is positioned on the other circumferential end face. The nonaqueous electrolyte (not shown) is held or impregnated in the electrode group 21. A first electrode lead 27 is electrically connected to the first current collector tab 25 and is also electrically connected to the first electrode terminal 23. A second electrode lead 28 is electrically connected to the second current collector tab 26 and is also electrically connected to the second electrode terminal 24. The electrode group 21 is disposed in the container member 20 such that the first electrode lead 27 and the second electrode lead 28 face the main surface side of the container member 20. The lid 22 is fixed to an opening 20a of the container member 20 by, e.g., welding. The first electrode terminal 23 and the second electrode terminal 24 are each attached to the lid 22 via an insulating hermetic seal member (not shown).

Since the battery according to the second embodiment explained above contains the stack of the embodiment, self-discharge can be suppressed. Also, since the insulation property can be maintained even when the thickness of the first film is reduced, the thickness of the separator containing the first film can be reduced, and the energy density of the battery can be improved. Further, the battery can be improved in durability performance such as cycle life performance.

### Third Embodiment

According to a third embodiment, a battery pack is provided. The battery pack contains the battery according to the embodiment.

The battery pack according to the embodiment may have a plurality of batteries. A plurality of batteries can be electrically connected in series or electrically connected in parallel. Alternatively, a plurality of batteries can be electrically connected in series and in parallel in combination. That is, the battery pack according to the embodiment may have a battery module. A plurality of battery modules can be used. A plurality of battery modules can be electrically connected in series or in parallel, or in series and in parallel in combination.

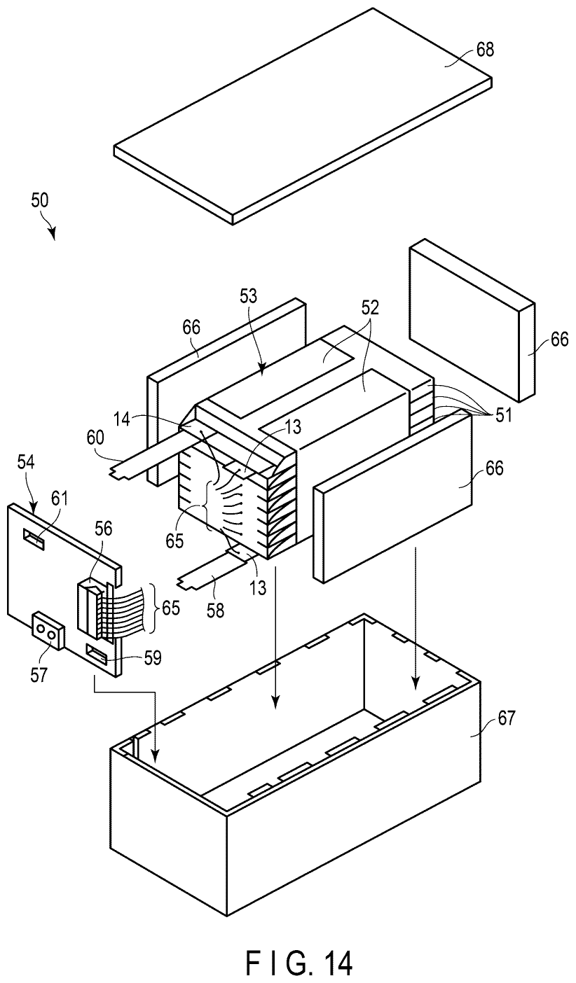

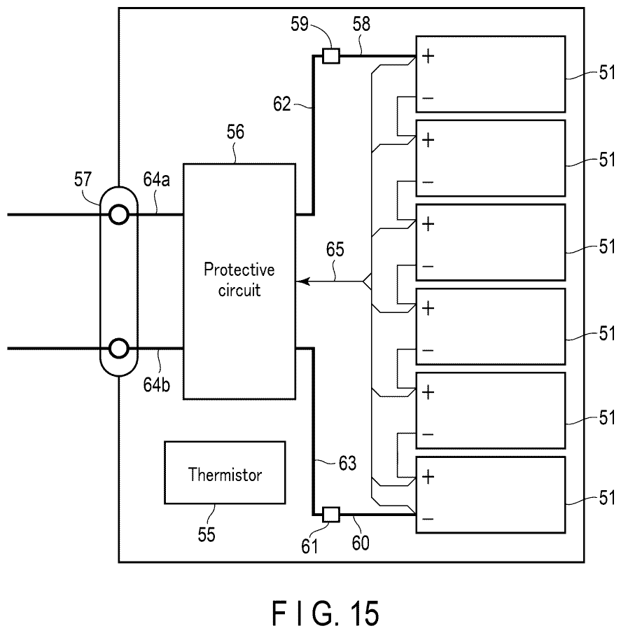

Now, the example of a battery pack according to an embodiment will be explained with reference to FIGS. 14 and 15, below. FIG. 14 is an exploded perspective view of the battery pack according to the embodiment. FIG. 15 is a block diagram of an electric circuit of the battery pack illustrated in FIG. 14.

The battery pack 50 illustrated in FIGS. 14 and 15 has a plurality of unit cells 51. The unit cell 51 may be, for example, the flat battery 10 according to the embodiment, which has been explained with reference to FIG. 12.

The plurality of unit cells 51 are stacked such that negative electrode terminals (second electrode terminals) 14 and positive electrode terminals (first electrode terminals) 13 extending to the outside are aligned in the same direction, and are fastened with an adhesive tape 52 to constitute a battery module 53. These unit cells 51 are mutually and electrically connected in series, as illustrated in FIG. 15.

A printed wiring board 54 is disposed so as to face a side surface from which the negative electrode terminals 14 and the positive electrode terminals 13 of the unit cell 51 extend. On the printed wiring board 54, as illustrated in FIG. 15, a thermistor 55, a protective circuit 56, and a power distribution terminal 57 to an external apparatus are mounted. The surface of the printed wiring board 54 facing the battery module 53 is equipped with an insulating plate (not shown) in order to avoid unnecessary connection with the wiring of the battery module 53.

A lead 58 on the positive electrode side is connected to the positive electrode terminal 13 positioned in the lowermost layer of the battery module 53, and the tip of the lead is inserted into a connector 59 on the positive electrode side of the printed wiring board 54 and electrically connected The negative electrode lead 60 is connected to the negative electrode terminal 14 positioned in the uppermost layer of the battery module 53, and the tip thereof is inserted into and electrically connected to the negative electrode connector 61 of the printed wiring board 54 and electrically connected. These connectors 59 and 61 are connected to the protective circuit 56 through wirings 62 and 63 formed on the printed wiring board 54.

The thermistor 55 detects the temperature of the unit cells 51, and detection signals thereof are transmitted to the protective circuit 56. The protective circuit 56 can cut off a positive-side wiring 64a and a negative-side wiring 64b between the protective circuit 56 and the power distribution terminal 57 to an external apparatus under a predetermined condition. The predetermined condition is, for example, the timing when the temperature detected by the thermistor 55 becomes a predetermined temperature or more. Further, another predetermined condition is, for example, the timing when, e.g., over-charge, over-discharge, or overcurrent of the unit cells 51 is detected. The detection of, e.g., over-charge, is performed for individual unit cells 51 or the entire battery module 53. When individual unit cells 51 are detected, the battery voltage may be detected, or the positive electrode potential or the negative electrode potential may be detected. In the latter case, a lithium electrode used as a reference electrode is inserted into each of the unit cells 51. In the battery pack 50 of FIGS. 14 and 15, a wiring 65 for voltage detection is connected to each of the unit cells 51. Detection signals are transmitted to the protective circuit 56 through the wirings 65.

To each of the three side surfaces of the battery module 53 excluding the side surface from which the positive electrode terminals 13 and the negative electrode terminals 14 protrude, a protective sheet 66 made of a rubber or a resin is disposed.

The battery module 53 is housed in a housing container 67 together with the protective sheets 66 and the printed wiring board 54. That is, the protective sheets 66 are disposed each on both inner side surfaces along the long side direction and an inner side surface along the short side direction of the housing container 67. On the other inner side surface along the short side direction on positioned on the opposite side via the battery module 53, the printed wiring board 54 is disposed. The battery module 53 is positioned in the space surrounded by the protective sheets 66 and the printed wiring board 54. A lid 68 is attached to the upper surface of the housing container 67.

Note that, the battery module 53 may be fixed with a heat-shrinkable tape in place of the adhesive tape 52. In this case, protective sheets are disposed on both side surfaces of the battery module, a heat-shrinkable tape is wound therearound, and then heat-shrunk to bind the battery module.

FIGS. 14 and 15 show an embodiment where the unit cells 51 are electrically connected in series, but the unit cells may be electrically connected in parallel in order to increase the battery capacity. Further, the battery packs constructed can be electrically connected in series and/or in parallel.

The conformation of the battery pack according to the embodiment is appropriately changed depending on the application. The battery pack according to the embodiment is preferably applied to a case where cycle performance in charging and discharging with a large current is desired. Examples of the application include uses of power supplies for digital cameras, and in-vehicle power supplies for two-wheel to four-wheel hybrid electric automobiles, two-wheel to four-wheel electric automobiles, and assist bicycles. The use of the battery pack according to the embodiment is particularly preferably in-vehicle applications.

The battery pack according to the third embodiment includes the battery according to the embodiment. Therefore, the battery pack according to the embodiment can suppress self-discharge, and simultaneously enhance energy density and durability performance.

### EXAMPLES

### Example 1

A secondary battery having a first electrode as a positive electrode and a second electrode as a negative electrode was produced by the following method. LiMn₂O₄ particles were prepared as a positive electrode active material, carbon black as a conductive material, and polyvinylidene fluoride as a binder. These were mixed in a mass ratio of 90:5:5 to obtain a mixture. Subsequently, the obtained mixture was dispersed in a solvent of n-methyl-2-pyrrolidone (NMP) to prepare slurry I.

TiO₂ particles (manufactured by TAYCA CORPORATION) whose surface was covered with Al₂O₃ particles were prepared as inorganic material particles. The median diameter D₅₀ of the inorganic material particles was 0.3 μm, and the specific surface area thereof was 12 m²/g.

As a binder polymer, homopolymer type PVdF (manufactured by KUREHA CORPORATION) having a weight average molecular weight of 500,000 was prepared. PVdF was dissolved in NMP in a concentration of 10 mass % to prepare a 10 mass % PVdF solution.

Slurry II was prepared so as to have a concentration of PVdF of 4 mass % relative to inorganic material particles, by the following method. First, the 10 mass % PVdF solution was added to an NMP solvent, and the mixture was stirred for 10 minutes with a stirrer with a rotary blade. To the mixture, the inorganic material particles were gradually added, and the mixture was stirred for 60 minutes. Further, these were dispersed by a bead mill filled with zirconia beads of 1 mmφ at a filling rate of about 50%. The conditions of the bead mill were a flow rate of 0.1 to 0.5 L/min and a peripheral speed of 5 to 10 m/sec. When slurry II after dispersion was subjected to grinding gauge measurement (JIS K5600-2-5), the size of coarse particles was 20 μm or less, and the number of the coarse particles was also small.

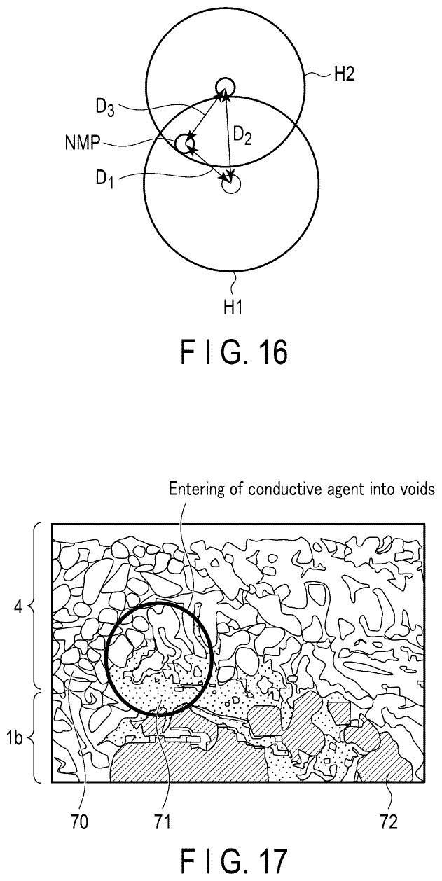

The measurement of the Hansen solubility parameter (HSP) representing the affinity of two components was performed by the method described below. First, inorganic material particles were added to each of 10 to 20 types of dispersion mediums containing NMP so as to have a concentration of 5 mass % to obtain 10 to 20 samples A different in type. Further, PVdF binder powder was added to each of 10 to 20 types of dispersion mediums containing NMP so as to have a concentration of 5 mass % to obtain 10 to 20 samples B different in type. The samples A and B thus obtained were subjected to pulse NMR measurement to obtain relaxation times. Based on this, it was determined that each of the 10 to 20 types of dispersion mediums containing NMP was a good solvent or a poor solvent for the inorganic material particles and the PVdF binder. From this result, Hansen solubility spheres with respect to the inorganic material particles and PVdF were obtained by calculation. An example is illustrated in FIG. 16. In FIG. 16, the Hansen solubility sphere of inorganic material particles is indicated by H1, and the Hansen solubility sphere of PVdF is indicated by H2. The difference between the central coordinates of these spheres was calculated and regarded as the HSP distance (Ra). The HSP distance (Ra₀₁) between NMP and inorganic material particles is represented by D1, the HSP distance (Ra₀₂) between PVdF and the inorganic material particles is represented by D2, and the HSP distance (Ra) between PVdF and NMP is represented by D3. D1 was 2.6, D2 was 3.96, and D3 was 2.73. The value of the ratio represented by D2 (Ra₀₂)/D1 (Ra₀₁) was 1.5.

Next, on the both surfaces of the aluminum foil of 12 μm in thickness, slurry I and slurry II were applied such that they are overlapped in this order and slurry II spreads out. Thereafter, slurry I and slurry II were dried. The dried coating film was subjected to roll pressing and cut into pieces of a predetermined size to obtain positive electrodes as a first electrode. Note that, a portion not supporting the positive electrode active material-containing layer was provided on one of the long sides of the current collector, and this portion was used as a positive electrode tab. The thickness of the first film formed from slurry II was 3 μm. The thickness of the positive electrode active material-containing layer was 20 μm.

On the other hand, a negative electrode as a second electrode was produced by the following method. Lithium titanate particles having a composition represented by Li₄Ti₅O₁₂ and having an average primary particle size of 0.5 μm, carbon black as a conductive agent, and polyvinylidene fluoride as a binder were prepared. These were mixed in a mass ratio of 90:5:5 to obtain a mixture. The obtained mixture was dispersed in a solvent of n-methyl-2-pyrrolidone (NMP) to prepare a slurry. The obtained slurry was applied to an aluminum foil of 12 μm in thickness and dried. Subsequently, the dried coating film was pressed to obtain a negative electrode. Note that a portion not supporting the negative electrode active material-containing layer was provided on one of the long sides of the current collector, and this portion was used as a negative electrode tab.

On the negative electrode, an organic fiber was deposited by an electrospinning method to form a second film. As the organic material, polyamide imide was used. The polyamide imide was dissolved in DMAc as a solvent in a concentration of 20 mass % to prepare a raw material solution as a liquid raw material. The obtained raw material solution was supplied from a spinning nozzle to the surface of the negative electrode at a supply rate of 5 μL/min using a metering pump. A voltage of 20 kV was applied to the spinning nozzle by a high voltage generator, and a layer of organic fibers was formed on the surface of the negative electrode by moving the spinning nozzle alone within the range of 100×200 mm. Note that, the surface of the negative electrode tab was masked except a portion of 10 mm from the boundary with the negative electrode active material-containing layer on both surfaces (main surfaces) of the negative electrode tab. In this state, an electrospinning method was carried out to obtain a negative electrode having the structure illustrated in FIG. 3. That is, the second film covered each of the surfaces (main surfaces) of the negative electrode active material-containing layer, four side surfaces orthogonal to the surface, three end faces of the negative electrode current collector which are located at the negative electrode surface, and a portion including a boundary with the negative electrode active material-containing layer on the surface of the negative electrode tab. The thickness of the negative electrode active material-containing layer was 15 μm. The thickness of the second film was 2 μm.

Subsequently, the negative electrode was pressed by a roll press. In the second film, the average diameter of the organic fibers was 700 nm, and 50% or more of the total volume of the fibers forming the second film was occupied by the organic fibers having an average diameter of 1 μm or less. The average pore size was 10 pam, and the porosity was 80%.

Next, a secondary battery was produced using the produced positive electrode and negative electrode.

The positive electrode and the negative electrode were disposed such that the positive electrode active material-containing layer and the negative electrode active material-containing layer faced each other with the first film and the second film interposed between them, and these were wound in a flat shape to obtain a flat spiral shape electrode group. After dried under vacuum at room temperature overnight, the electrode group was allowed to stand in a glove box having a dew point of −80° C. or lower for one day. The electrode group was housed in a metal container together with an electrolytic solution to obtain a nonaqueous electrolyte battery of Example 1.

The electrolytic solution used was prepared by dissolving LiPF₆ in ethylene carbonate (EC) and dimethyl carbonate (DMC).

The battery was charged to a state of 70% SOC and allowed to stand in a thermostatic bath at 25° C. to obtain a temporal change of voltage. As a result, the voltage drop was 0.75 mV/day. It was found that self-discharge was suppressed.

### Example 2

A nonaqueous electrolyte battery was produced in the same manner as in Example 1 except that a first film was produced by the following method.

As inorganic material particles, barium sulfate (BaSO₄) particles (manufactured by KINSEI MATEC CO., LTD.) having a median diameter D₅₀ of 0.6 μm were prepared.

As the binder polymer, the same type of PVdF as that explained in Example 1 was used. PVdF was dissolved in NMP in a concentration of 10 mass % to prepare a 10 mass % PVdF solution.

Slurry II was prepared so as to have a concentration of PVdF of 4 mass % relative to inorganic material particles, by the following method. First, the 10 mass % PVdF solution was added to an NMP solvent, and the mixture was stirred for 10 minutes with a stirrer with a rotary blade. To the mixture, the inorganic material particles were gradually added, and the mixture was stirred for 60 minutes. Further, these were dispersed by a bead mill filled with zirconia beads of 1 mmφ at a filling rate of about 50%. The conditions of the bead mill were a flow rate of 0.1 to 0.5 L/min and a peripheral speed of 5 to 10 m/sec. When slurry II after dispersion was subjected to grinding gauge measurement (JIS K5600-2-5), the size of coarse particles was 30 μm or less, and the number of coarse particles was also small.

When D1 to D3 were determined in the same manner as in Example 1, D1 was 4.07, D2 was 2.35, and D3 was 2.73. When the ratio represented by D2 (Ra₀₂)/D1 (Ra₀₁) was calculated, the ratio was 0.58.

The obtained battery was charged to a state of 70% SOC and allowed to stand in a thermostatic bath at 25° C. to obtain a temporal change in voltage. As a result, the voltage drop was 0.5 mV/day. It was found that self-discharge was suppressed.

### Comparative Example 1

As the inorganic material particles, titania particles (manufactured by Titan Kogyo, Ltd.) having a median diameter D₅₀ of 0.3 μm were prepared. As the binder polymer, a modified (copolymer) PVdF (manufactured by Solvay) having an average molecular weight of 1 million to 1.2 million was prepared. A small amount of the polymer was dispersed with a tabletop stirrer under the same dispersion conditions as in Example 1. As a result of the grinding gauge, a large number of coarse particles were observed. It was found that dispersion could not be made. Due to the presence of a large number of coarse particles, an electrode could not be prepared, and consequently a battery could not be prepared. When D1 to D3 were determined in the same manner as in Example 1, D1 was 2.6, D2 was 6.72, and D3 was 4.14. When the ratio represented by D2 (Ra₀₂)/D1 (Ra₀₁) was calculated, the ratio was 2.6.

### Comparative Example 2

As the inorganic material particles, alumina (Al₂O₃) particles (manufactured by Nippon Light Metal Co., Ltd.) having a median diameter D₅₀ of 1.1 μm were used. As the binder polymer, the same type of PVdF as in Comparative Example 1 was used. PVdF was dissolved in NMP in a concentration of 10 mass % to prepare a 10 mass % PVdF solution.

Slurry II was prepared so as to have a concentration of PVdF of 4 mass % relative to inorganic material particles, by the following method. First, the 10 mass % PVdF solution was added to an NMP solvent, and the mixture was stirred for 10 minutes with a stirrer with a rotary blade. To the mixture, the inorganic material particles were gradually added, and the mixture was stirred for 60 minutes. When slurry II after dispersion was subjected to grinding gauge measurement (JIS K5600-2-5), the leveling property was poor and no discrimination was made.

D1 to D3 were determined in the same manner as in Example 1. When the ratio represented by D2 (Ra₀₂)/D1 (Ra₀₁) was calculated, the ratio was 1.7.

A nonaqueous electrolyte battery was produced in the same manner as in Example 1 except that the first film was produced by the above method. The average pore diameter of the first film was measured by the method described above, and found to be 0.8 μm.

The obtained battery was charged to a state of 70% SOC and allowed to stand in a thermostatic bath at 25° C. to obtain a temporal change in voltage. As a result, the voltage drop was 0.8 mV/day. A schematic view of an SEM image of a cross section of the first film of Comparative Example 2 taken along the thickness direction is illustrated in FIG. 17. As illustrated in FIG. 17, it is found that the conductive agent 71 enters in the voids generated by the aggregation of the inorganic material particles 70 in the first film 4. The conductive agent 71 is a component of the positive electrode active material 72 containing layer 1b. As a result that the conductive agent 71 entered in the first film 4, the insulation property of the first film 4 deteriorated.

### Comparative Example 3

A nonaqueous electrolyte battery having the same constitution as that of Comparative Example 2 was produced except that the average pore diameter of the first film 4 was 0.5 μm.

The obtained battery was charged to a state of 70% SOC and allowed to stand in a thermostatic bath at 25° C. to obtain a temporal change in voltage. As a result, the voltage drop was 0.23 mV/day. It was found that the self-discharge was further suppressed than in Comparative Example 2.

Table 1 shows the type of the inorganic material, and measurement results of the median diameter D₅₀ (μm), Ra₀₂/Ra₀₁, the average pore diameter (μm), the evaluation result of dispersion degree by a grinding gauge, and the self-discharge rate (mV/day) of the inorganic material particles of Examples and Comparative Examples. The methods for measuring the median diameter D₅₀ (μm), Ra₀₂/Ra₀₁, and the average pore diameter (μm) are the same as described above.

TABLE 1

| | | Average | | Average | | Self- |
|---|---|---|---|---|---|---|
| | | particle | | pore | Evaluation result of | discharge |
| | Inorganic | diameter D50 | Ra₀₂/ | diameter | dispersion degree | rate |
| | material | (μm) | Ra₀₁ | (μm) | (μm) | (mV/day) |
| Example 1 | Titania | 0.3 | 1.5 | 0.4 | 20 μm or less | 0.75 |
| Example 2 | Barium sulfate | 0.6 | 0.58 | 0.3 | 30 μm or less | 0.5 |
| Comparative | Titania | 0.3 | 2.6 | — | Many coarse particles | — |
| Example 1 | | | | | | |
| Comparative | Alumina | 1.1 | 1.7 | 0.8 | The leveling property | 0.8 |
| Example 2 | | | | | was poor, and | |
| | | | | | discrimination was not | |
| | | | | | made. | |
| Comparative | Alumina | 1.1 | 1.7 | 0.5 | The leveling property | 0.23 |
| Example 3 | | | | | was poor, and | |
| | | | | | discrimination was not | |
| | | | | | made. | |

As is apparent from Table 1, the self-discharge of the batteries of Examples 1 and 2 can be suppressed. In addition, since the first films of the batteries of Example 1 and Example 2 are low in the number of coarse particles and high in denseness, the insulation property can be maintained over a long period of time. Therefore, the batteries of Examples 1 and 2 are excellent in life performance.

In contrast, in each of the first films of Comparative Examples 2 and 3, the median diameter of the inorganic material particles was larger and the number of coarse particles was larger compared to those in Examples 1 and 2. In the battery of Comparative Example 3, the average pore diameter of the first film is 0.5 μm or less. Due to this, the self-discharge can be suppressed as compared with Comparative Example 2, but the denseness of the first film is inferior, with the result that the durability of the first film is poor, and the life performance of the battery is low.

The stack according to at least one of the embodiments and Examples mentioned above contains inorganic material particles having a median diameter D₅₀ of 0.6 μm or less and a polymer, and contains a first film having an average pore diameter of 0.5 μm or less and satisfying the following formula (1).

$$0 < {Ra}_{02} / {Ra}_{01} \leq 1.5 \qquad ( 1 )$$

where Ra₀₁ is the HSP distance between inorganic material particles and n-methyl-2-pyrrolidone based on Hansen solubility parameter values (HSP values), and Ra₀₂ is the HSP distance between the inorganic material particles and the polymer based on Hansen solubility parameter values (HSP values).

According to the stack, since the aggregation of the inorganic material particles can be suppressed, the denseness of the first film can be enhanced. As a result, it is possible to provide a battery suppressed in self-discharge and excellent in durability.

While certain embodiments have been described, these embodiments have been presented by way of example only, and are not intended to limit the scope of the invention.

Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

The inventions of the embodiments are appended.

<1>. A stack including
a first current collector;
a first active material-containing layer provided in at least a surface of the first current collector; and
a first film covering at least a part of a surface of the first active material-containing layer in which the first current collector is not provided, the first film including inorganic material particles having a median diameter D₅₀ of 0.6 μm or less and a polymer, first film having an average pore diameter of 0.5 μm or less, and first film satisfying the following formula (1):

$$0 < {Ra}_{02} / {Ra}_{01} \leq 1.5 \qquad ( 1 )$$

where Ra₀₁ is a HSP distance between the inorganic material particles and n-methyl-2-pyrrolidone based on Hansen solubility parameter values (HSP values), and Ra₀₂ is a HSP distance between the inorganic material particles and the polymer based on Hansen solubility parameter values (HSP values).

<2>. The stack according to <1>, wherein the first film includes n-methyl-2-pyrrolidone.

<3>. The stack according to <1> or <2>, wherein the inorganic material particles have a specific surface area of 30 m²/g or less.

<4>. The stack according to any one of <1> to <3>, wherein the inorganic material particles include at least one compound selected from the group consisting of a titanium oxide, an aluminum oxide, and a barium sulfate.

<5>. The stack according to any one of <1> to <4>, wherein the inorganic material particles include at least one of particles whose surface is at least partially covered with an aluminum oxide and including a titanium oxide or particles including barium sulfate.

<6>. The stack according to any one of <1> to <5>, wherein an amount of the polymer is 20 mass % or less when a total amount of the inorganic material particles and the polymer in the first film is 100 mass %.

<7>. The stack according to any one of <1> to <6>, wherein the polymer is a binder polymer.

<8>. The stack according to any one of <1> to <7>, wherein the first active material-containing layer includes a positive electrode active material as an active material.

<9>. The stack according to any one of <1> to <8>, further including
a second current collector;
a second active material-containing layer provided in at least a surface of the second current collector; and
a second film positioned between the second active material-containing layer and the first film and including an organic fiber.

<10>. A battery including the stack according to any one of <1> to <9>.

<11>. A battery pack including a battery including the stack according to any one of <1> to <9>.

What is claimed is:

1. A stack comprising
a first current collector;
a first active material-containing layer provided in at least a surface of the first current collector; and
a first film covering at least a part of a surface of the first active material-containing layer in which the first current collector is not provided, the first film comprising inorganic material particles having a median diameter D₅₀ of 0.6 μm or less and a polymer, the first film having an average pore diameter of 0.5 μm or less, and the first film satisfying the following formula (1):
$$0 < {Ra}_{02} / {Ra}_{01} \leq 1.5 \qquad ( 1 )$$
where Ra₀₁ is a HSP distance between the inorganic material particles and n-methyl-2-pyrrolidone based on Hansen solubility parameter values (HSP values), and Ra₀₂ is a HSP distance between the inorganic material particles and the polymer based on Hansen solubility parameter values (HSP values).

2. The stack according to claim 1, wherein the first film comprises n-methyl-2-pyrrolidone.

3. The stack according to claim 1, wherein the inorganic material particles have a specific surface area of 30 m²/g or less.

4. The stack according to claim 1, wherein the inorganic material particles comprise at least one compound selected from the group consisting of a titanium oxide, an aluminum oxide, and a barium sulfate.

5. The stack according to claim 1, wherein the inorganic material particles comprise at least one of particles whose surface is at least partially covered with an aluminum oxide and comprising a titanium oxide or particles comprising barium sulfate.

6. The stack according to claim 1, wherein an amount of the polymer is 20 mass % or less when a total amount of the inorganic material particles and the polymer in the first film is 100 mass %.

7. The stack according to claim 1, wherein the polymer is a binder polymer.

8. The stack according to claim 1, wherein the first active material-containing layer comprises a positive electrode active material as an active material.

9. The stack according to claim 1, further comprising
a second current collector;
a second active material-containing layer provided in at least a surface of the second current collector; and
a second film positioned between the second active material-containing layer and the first film and comprising an organic fiber.

10. A battery comprising the stack according to claim 1.

11. A battery pack comprising a battery comprising the stack according to claim 1.
